(19) United States
(12) Patent Application Publication
(10) Pub. No.: US 2022/0238027 A1
(43) Pub. Date: Jul. 28, 2022

(54) APPLICATION FOR PROCESSING DISTRIBUTED FLIGHT DATA

(71) Applicant: The Boeing Company, Chicago, IL (US)

(72) Inventor: John Desmond Whelan, Burien, WA (US)

(73) Assignee: The Boeing Company

(21) Appl. No.: 17/502,709

(22) Filed: Oct. 15, 2021

Related U.S. Application Data
(60) Provisional application No. 63/142,012, filed on Jan. 27, 2021.

(51) Int. Cl. G08G 5/00; G06F 9/455; G06F 9/50

(52) U.S. Cl. CPC G08G 5/0017; G06F 9/50; G06F 9/45558

(57) ABSTRACT

A method performed by a computing system configured to process distributed flight data is described. The computing systems obtains distributed flight data from a communication system operating externally from the computing system. The computing system creates a record identifying the distributed flight data in a queue of the computing system. The computing system processes the distributed flight data identified in the record of the queue using a plurality of virtualized environments (VEs) of the computing system, each VE of the plurality of VEs comprising a task scheduler and a containerized application that operates to process the distributed flight data. The computing system further provides processed flight data to a plurality of different client communication systems operating externally from the computing system.

### CROSS-REFERENCE TO RELATED APPLICATIONS

The present application claims benefit of priority to U.S. Provisional Patent Application No. 63/142,012 filed Jan. 27, 2021.

### TECHNICAL FIELD

The present disclosure relates generally to computing systems processing distributed data and more specifically to computing systems processing distributed flight data in real-time.

### BACKGROUND

With data becoming more and more abundant, there seems to be a crucial need to process it as quickly as possible, in a scalable and efficient manner. The challenge is constructing a system flexible enough to accommodate growth, yet rigorous enough to retain the data's integrity. Moreover, not all forms of data are easy to obtain and process in real-time. Flight data, for example presents many challenges aside from its physical location (i.e., in the air). Heavy volumes combined with an assorted disbursement, makes collecting this type of data difficult.

For example, at any given moment there can be a large number of aircraft flying over a particular area, all belonging to different airlines. As a result, each could use differing mechanisms to process their corresponding data. While in flight, information residing within an airline's fleet becomes part of a larger fragmented population. When ground stations attempt to collect this data, the ensuing systems need to handle it accordingly; keeping the individual records together; while maintaining the airline's overall processing capabilities. Consequently, such a task can be difficult to maintain and scale, as the system needs to correlate large volumes of diverse data with paralleling airlines.

A problem of data continuity and persistence may also arise when a system attempts to process such large volumes of diverse data. For example, if a record was to become corrupt, the system could be delayed in processing non-corrupt data while it attempts to process the corrupted data. Delays in processing even a small portion of large values of diverse data can lead to significant processing delays if they are not handled efficiently. Thus, there is a need to process large volumes of distributed data in real time while maintaining data integrity in a resource scalable and efficient manner.

### SUMMARY

According to embodiments, a method performed by a computing system configured to process distributed flight data is described. The method includes obtaining distributed flight data from a communication system operating externally from the computing system. The method also includes creating a record identifying the distributed flight data in a queue of the computing system. The method also includes processing the distributed flight data identified in the record of the queue using a plurality of virtualized environments (VEs) of the computing system, each VE of the plurality of VEs comprising a task scheduler and a containerized application that operates to process the distributed flight data. The method further includes providing processed flight data to a plurality of different client communication systems operating externally from the computing system.

According to some embodiments, a computing system configured to process distributed flight data is described. The computing system comprises a first interface configured to communicate with a communication system operating externally from the computing system. The computing system also comprises a second interface configured to communicate with a plurality of different client communication systems operating externally from the computing system. The computing system also comprises processing circuitry and memory comprising executable instructions that when executed by the processing circuitry causes the processing circuitry to perform operations of the methods described above and herein below.

According to some embodiments, a computer program product comprised on a non-transitory computer readable storage medium is described. The computer program product comprises executable instructions that when executed by processing circuitry of a computing system that operates to process distributed flight data, causes the computing system to perform operations of the methods described above and herein below.

The systems and methods described in the present disclosure increase the proficiency of processing large volumes of distributed, dispersed, and different types of data in real time without compromising the integrity of the data. In addition, the solutions described herein can add or remove processing resources as needed, making the systems scalable in real-time as well. Additional advantageous of the systems and methods presented in the present disclosure are also discussed throughout the present disclosure.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a block diagram illustrating an example computing system in communication with a communication system and a plurality of client communication systems in accordance with embodiments of the present disclosure;

FIG. 2 is a block diagram illustrating an example computing system configured to process distributed flight data in accordance with embodiments of the present disclosure;

FIG. 3 is a flow chart illustrating a method performed by the computing system in accordance with embodiments of the present disclosure;

FIG. 4 is a flow chart illustrating a method of creating the record identifying the distributed flight data in the selected queue of the plurality of different queues in accordance with embodiments of the present disclosure;

FIG. 5 is a flow chart illustrating a method of increasing a retry count associated with a record in accordance with embodiments of the present disclosure;

FIG. 6 is a flow chart illustrating a method of removing the record in accordance with embodiments of the present disclosure;

FIG. 7 is a flow chart illustrating a method of operating the task scheduler to allocate one or more containerized applications in accordance with embodiments of the present disclosure;

FIG. 8 is a flow chart illustrating a method of operating the task scheduler to obtain a total number of the plurality of containerized applications of the VE, a number of containerized applications currently running in the VE, a number of records to process in the queue, and a total number of containerized applications that have stopped running in the VE in accordance with embodiments of the present disclosure;

FIG. 9 is a flow chart illustrating a method of deallocating the one or more containerized applications of the VE based on determining there are no records in the queue to process in accordance with embodiments of the present disclosure;

FIG. 10 is a flow chart illustrating a method of operating the task scheduler to retrying allocation of the one or more containerized applications in the VE to process the distributed flight data after the pre-determined period of time in accordance with embodiments of the present disclosure;

FIG. 11 is a flow chart illustrating a method of providing access to the processed flight data to the plurality of different client communication systems via an interface of the database system in accordance with embodiments of the present disclosure;

FIG. 12 is a flow chart illustrating a method of exposing the processed flight data associated with the client communication system based on the unique Key in accordance with embodiments of the present disclosure;

FIG. 13 is a diagram illustrating an example distributed computing system in accordance with embodiments of the present disclosure;

FIG. 14 is a flow diagram illustrating a processing method in accordance with embodiments of the present disclosure;

FIG. 15A is a diagram illustrating an example user interface displaying contents of a queue in accordance with embodiments of the present disclosure;

FIG. 15B is a diagram illustrating an example user interface displaying retry counts of records of a queue in accordance with embodiments of the present disclosure;

FIG. 16 is an example user interface illustrating a user setting up a virtual environment in accordance with embodiments of the present disclosure;

FIG. 17 is a block diagram illustrating example containerized applications in accordance with embodiments of the present disclosure;

FIG. 18 is an example user interface illustrating baseline containers within a virtual environment in accordance with embodiments of the present disclosure;

FIG. 19 is an example user interface illustrating multiple containers running within a virtual environment in accordance with embodiments of the present disclosure;

FIG. 20 is an example user interface illustrating a user setting up a task scheduler in accordance with embodiments of the present disclosure;

FIG. 21 is a flow diagram illustrating an example task scheduler process in accordance with embodiments of the present disclosure;

FIG. 22 is a block diagram illustrating an example API for providing the processed data to a client communication system in accordance with embodiments of the present disclosure; and

FIG. 23 is a diagram illustrating an example distributed computing system in communication with an airline communication system and a client communication system in accordance with embodiments of the present disclosure.

### DETAILED DESCRIPTION

The systems and methods of the present disclosure will now be described more fully hereinafter with reference to the accompanying drawings, in which examples of embodiments of the present disclosure are shown. The present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The present disclosure describes systems and methods that increase the proficiency of processing large volumes of distributed data in real time. Using the method and procedures described herein, the present disclosure correlates the movement of distributed data very efficiently without compromising its integrity. Because the methods and systems described herein can add or remove computing resources as needed, the system is scalable in real time as well. In addition, the systems and method described herein bypasses the need to organize the distributed data by immediately selecting objects, queuing them, and processing each data of the distributed data within an individual resource. Then, the present disclosure describes systems and methods to scale resources to account for processing demand.

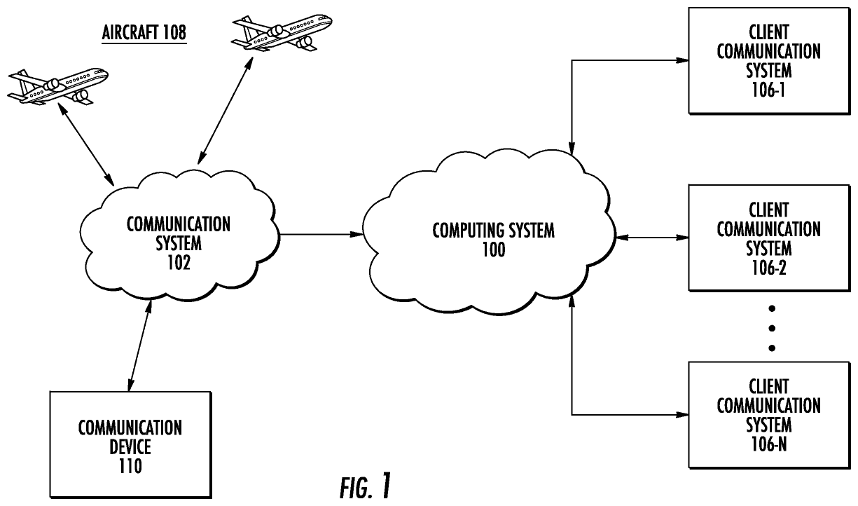

FIG. 1 illustrates an example computing system 100 in communication with a communication system 102 and a plurality of client communication systems 106-1 to 106-N according to some embodiments of the present disclosure. According to embodiments, computing system 100 is configured to process distributed flight data. In some embodiments, computing system 100 comprises a cloud computing system comprising multiple networked computing devices sharing computing resources to process large volumes of data. In some embodiments, the communication system 102 comprises one of an aerial communication system and an airline communication system operating externally to the computing system. For example, FIG. 1 illustrates communication system 102 in communication with one or more aircraft 108. In some embodiments, communication system 102 comprises one of a ground communication system and a satellite communication system of the aerial communication system that exchanges communications with the aircraft 108 during flight and while on the ground. In some embodiments, the plurality of client communication systems 106-1 to 106-N are associated with airlines that operate the one or more aircraft 108 associated with the distributed flight data. In some embodiments, the distributed flight data comprised information associated with the flights executed by the aircraft 108.

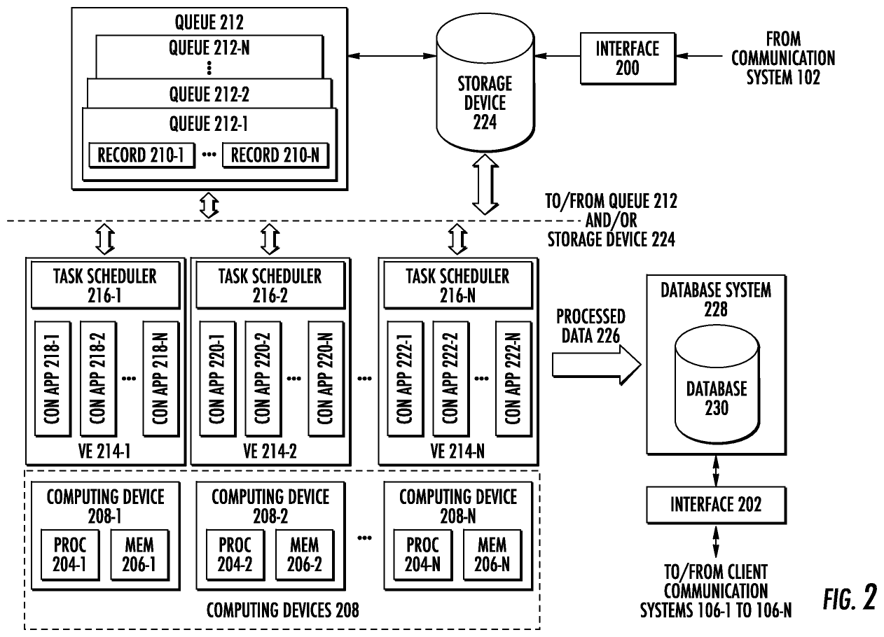

According to some embodiments, a computing system configured to process distributed flight data is described. The computing system comprises a first interface configured to communicate with a communication system operating externally from the computing system according to embodiments. The computing system also comprises a second interface configured to communication with a plurality of different client communication systems operating externally from the computing system. For example, FIG. 2 illustrates computing system 100 comprises a first interface 200 configured to communicate with communication system 102 operating externally from computing system 100. Computing system 100 also comprises a second interface 202 configured to communication with client communication systems 106-1 to 106-N that operate externally from computing system 100 as shown in FIG. 2.

The computing system also comprises processing circuitry and memory comprising executable instructions that when executed by the processing circuitry causes the processing circuitry to perform operations according to the methods described herein. In some embodiments, the processing circuitry comprises one or more processors of one more computing devices of the computing system. The memory also comprises, in some embodiments, one or more memories of the one or more computing devices of the computing system. For example, FIG. 2 illustrates example computing system 100 comprises processors 204-1 to 204-N and memories 206-1 to 206-N of computing devices 208-1 to 208-N respectively of computing devices 208 of computing system 100.

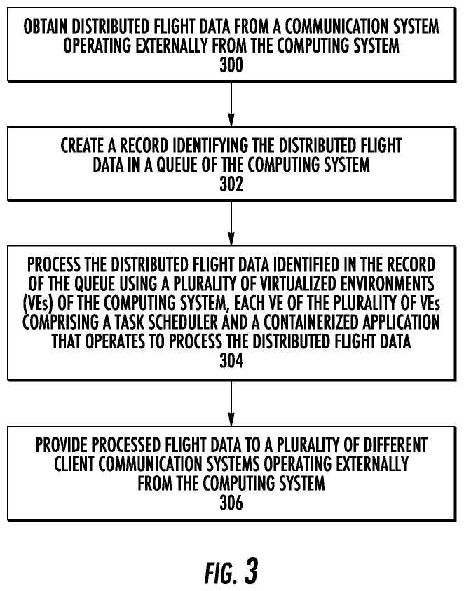

FIG. 3 illustrates a method performed by a computing system configured to process distributed flight data according to embodiments of the present disclosure. The method includes obtaining 300 distributed flight data from a communication system operating externally from the computing system. For example, FIG. 1 illustrates computing system 100 obtains distributed flight data from communication system 102 operating externally from computing system 100. In some embodiments, the computing system obtains the distributed flight data using the first interface of the computing system. For example, FIG. 2 illustrates computing system 100 obtains the distributed flight data using interface 200 of computing system 100. In some embodiments, the method includes receiving the distributed flight data from different communication devices operating in one of the aerial communication system and the airline communication system operating externally to the distributed computing system. For example, FIG. 1 illustrates computing system 100 receives distributed flight data from different communication devices, such as aircraft 112 or communication device 110. In some embodiments, communication device 110 comprises a component of a ground communication system of the aerial communication system. In another embodiment, the communication device 110 comprises a computing device of the airline communication system.

Returning to FIG. 3, the method also includes creating 302 a record identifying the distributed flight data in a queue of the computing system. In some embodiments, the queue comprises a plurality of different queues of the computing system. In this embodiment, the method includes creating the record identifying the distributed flight data in a queue of the plurality of different queues of the computing system. For example, FIG. 2 illustrates computing system 100 creates a record 210-1 in queue 212-1 of queue 212 identifying distributed flight data. Queue 212 comprises a plurality of different queues 212-1 to 212-N as shown in FIG. 2. In some embodiments, a queue of the plurality of queues comprises a plurality of records identifying different distributed flight data. For example, FIG. 2 illustrates queue 212-1 comprises a plurality of records 210-1 to 210-N identifying different distributed flight data.

In some embodiments, each queue of the plurality of different queues is associated with a different client communication system of the plurality of different client communication systems that operate externally to the communication system. For example, each queue of the plurality of queues 212-1 to 212-N illustrated in FIG. 2 is associated with a different client communication system of client communication systems 106-1 to 106-N shown in FIG. 1. According to some embodiments, FIG. 4 illustrates the method includes identifying 400 a client communication system of the plurality of different client communication systems associated with the distributed flight data. The method also includes selecting 402 the queue of the plurality of different queues based on the identification of the client communication system of the plurality of client communications systems associated with the distributed flight data.

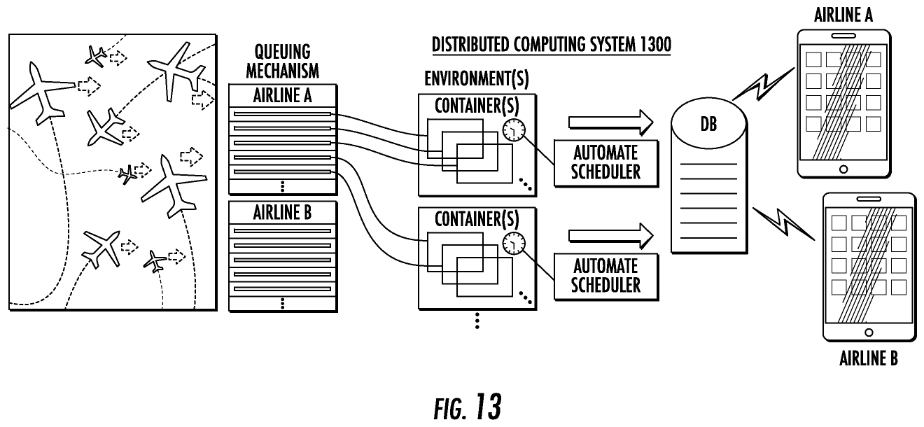

For example, computing system 100 identifies client communication system 106-1 is associated with distributed flight data. In this example, queue 212-1 illustrated in FIG. 2 is associated with client communication system 106-1. Computing system 100 thus selects queue 212-1 based on the identification of client communication system 106-1 associated with the distributed flight data. Returning to FIG. 4, the method also includes creating 404 the record identifying the distributed flight data in the selected queue of the plurality of different queues. Continuing the previous example, computing system 100 creates record 210-1 identifying the distributed flight data in selected queue 210-1 as shown in FIG. 2. Additional embodiments and examples with regards creating a record identifying distributed flight data in a selected queue of a plurality of queues is discussed below with regards to FIGS. 13-15.

In some embodiments, the method includes determining the distributed flight data has been successfully processed. In these embodiments, the method also includes removing the record identifying the distributed flight data to be processed from the queue based on determining the distributed flight data has been successfully processed. For example, computing system 100 illustrated in FIGS. 1 and 2 determines the distributed flight data has been successfully processed and removes record 210-1 identifying the distributed flight data from queue 212-1 based on determining the distributed flight data has been successfully processed.

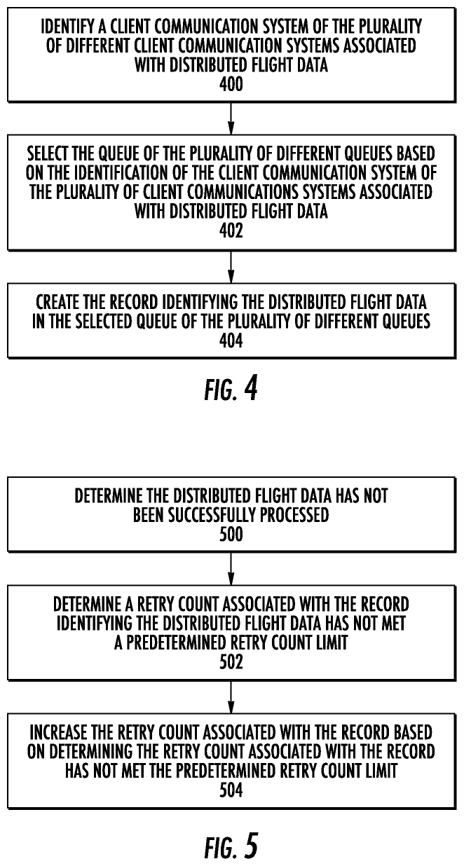

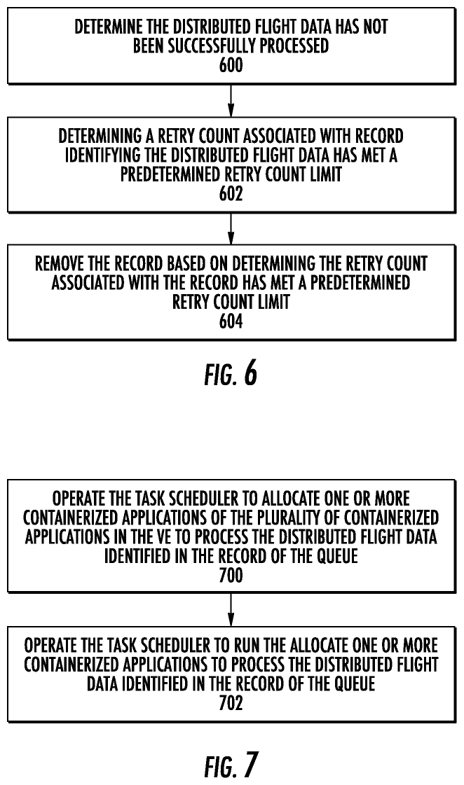

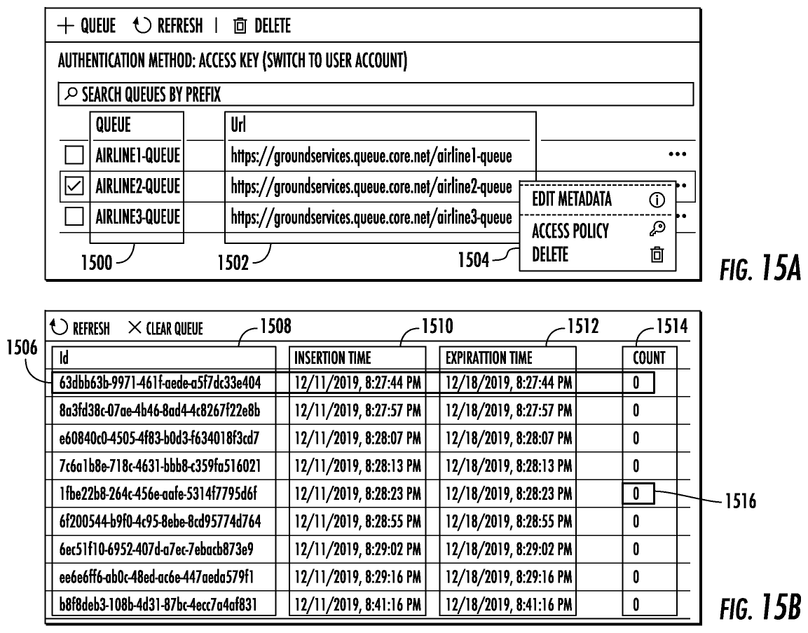

In some other embodiments, the method includes determining 500, 600 the distributed flight data has not been successfully processed as shown in FIGS. 5 and 6, respectively. In some embodiments, the method includes determining 502 retry count associated with the record identifying the distributed flight data has not met a predetermined retry count limit. FIG. 5 also illustrates the method includes increasing 504 the retry count associated with the record based on determining the retry count associated with the record has not met the predetermined retry count limit. For example, computing system 100 illustrated in FIGS. 1 and 2 determines the distributed flight data has not been successfully processed and also determines a retry count associated with record 210-1 identifying the distributed flight data has not met a predetermined retry count limit. In this example, computing system 100 increases the retry count associated with record 210-1 based on determining the retry count associated with record 210-1 has not met the predetermined retry count limit. Additional embodiments and examples with regards to determining the retry count has not met the predetermined retry count limits is discussed below with regards to FIG. 15.

In some other embodiments, the method includes determining 602 a retry count associated with the record identifying the distributed flight data has met a predetermined retry count limit. In this embodiment the method also includes removing 604 the record based on determining the retry count associated with the record has met the predetermined retry count limit. For example, computing system 100 illustrated in FIGS. 1 and 2 determines the retry count associated with record 210-1 identifying the distributed flight data has met a predetermined retry count limit. In this example, computing system 100 removes record 210-1 based on determining the retry count associated with record 210-1 has met the predetermined retry count limit. Additional embodiments and examples with regards to determining the retry count has met the predetermined retry count limits is discussed below with regards to FIG. 15.

Returning to FIG. 3, the method includes processing 304 the distributed flight data identified in the record of the queue using a plurality of virtualized environments (VEs) of the computing system. In accordance with embodiments, each VE of the plurality of VEs comprises a task scheduler and a containerized application that operates to process the distributed flight data. For example, FIG. 2 illustrates computing system 100 processes the distributed flight data identified in record 210-1 of queue 212-1 using a plurality of VEs 214-1 to 214-N. FIG. 2 also illustrates each VE of VEs 214-1 to 214-N comprises respective task schedulers 216-1 to 216-N. FIG. 2 also illustrates task schedulers 216-1 to 216-N each comprise a containerized application 218-1, 220-1, and 222-1 respectively that operate to process the distributed flight data.

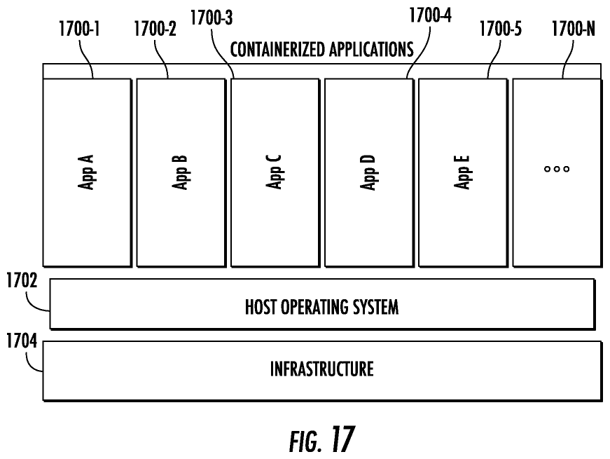

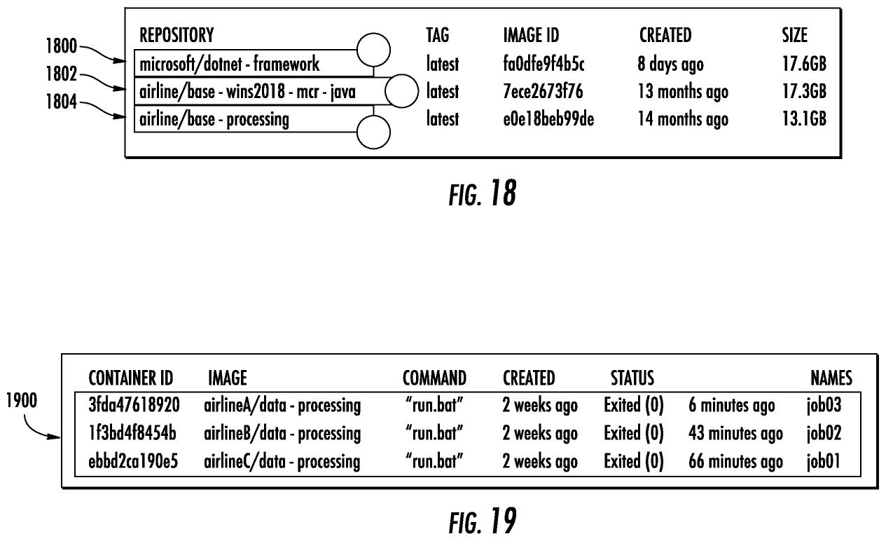

In some embodiments, the method includes selecting the plurality of VEs to process the distributed flight data based on an amount of computing resources required to process the distributed flight data identified in the record of the queue. For example, computing system 100 selects VEs 214-1 to 214-N to process the distributed flight data based on an amount of computing resources, such as computing devices 208-1 to 208-N, processors 204-1 to 204-N, and memory 206-1 to 206N, required to process the distributed flight data identified in record 210-1 of queue 212-1. In some embodiments, the method includes receiving, from a user interface of the computing system, a selection of the plurality of VEs to process the distributed flight data identified in the record of the queue. For example, computer system 100 receives, from a user interface (not shown in FIGS. 1 and 2) of computing system 100, a selection of VEs 214-1 to 214-N to process the distributed flight data identified in record 210-1 of queue 212-1. Additional examples and embodiments with regards to receiving the selection of the plurality of VEs from a user interface of the computing system is discussed below with regards to FIGS. 17-18.

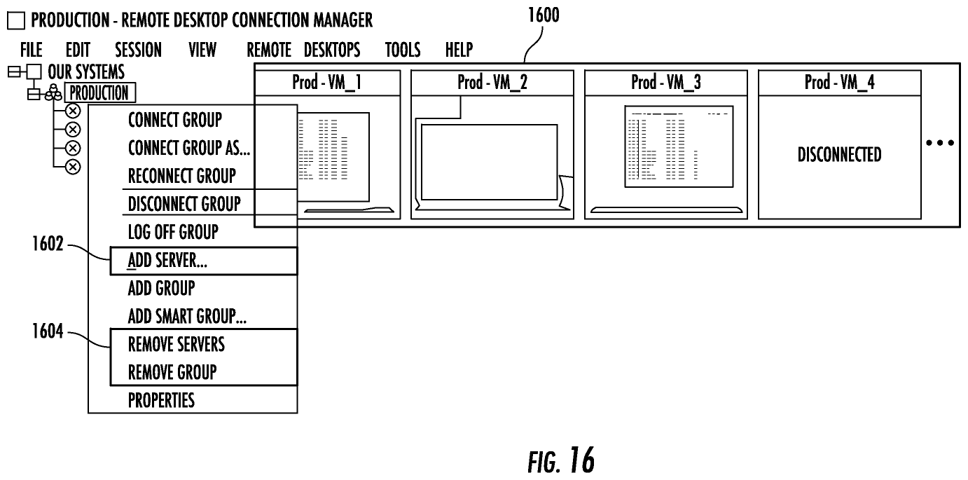

Each VE of the plurality of VEs comprises a plurality of containerized applications and each containerized application of the plurality of containerized applications of each VE comprises independently executable instructions configured to process the distributed flight data according to some embodiments. For example, FIG. 2 illustrates VE 214-1 comprises a plurality of containerized applications 218-1 to 218-N. Each containerized application 218-1 to 218-N comprises independently executable instructions configured to process the distributed flight data. FIG. 2 also illustrates VE 214-2 comprises a plurality of containerized applications 220-1 to 220-N and VE 214-N comprises a plurality of containerized applications 222-1 to 222-N. Additional examples and embodiments with regards to the containerized applications of the present disclosure are discussed below with regards to FIGS. 16-18.

In some embodiments, the record identifying the distributed flight data to be processed comprises information identifying a storage device of the computing system storing the distributed flight data. In this embodiment, each containerized application of the plurality of containerized applications of each VE obtains the distributed flight data from the storage device based on the information identifying the storage device in the record. For example, record 210-1 illustrated in FIG. 2 identifies storage device 224 of computing system 100 storing the distributed flight data. Each containerized application 218-1 to 218-N, for example, of VE 214-1 obtains the distributed flight data from storage device 224 based on the information identifying the storage device in record 210-1. Containerized applications 220-1 to 220-N of VE 214-2 and 222-1 to 222-N of VE 214-N operate in a similar manner. Additional examples and embodiments with regards to the containerized applications of the present disclosure are discussed below with regards to FIGS. 16-18.

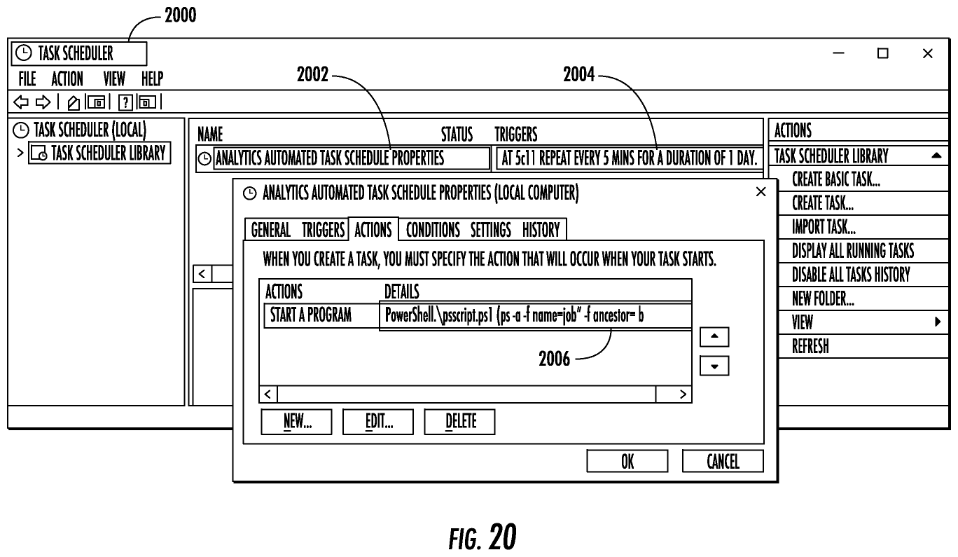

FIG. 7 illustrates the method includes, for each VE of the plurality of VE, operating 700 the task scheduler to allocate one or more containerized applications of the plurality of containerized applications in the VE to process the distributed flight data identified in the record of the queue according to some embodiments. In this embodiment, the method also includes operating 702 the task scheduler to run the allocated one or more containerized applications to process the distributed flight data identified in the record of the queue as shown in FIG. 7. For example, task scheduler 216-1 of VE 214-1 illustrated in FIG. 2 operates to allocate one or more containerized applications 218-1 to 218-N to process the distributed flight data identified in record 210-1. In this example, task scheduler 216-1 also operates to run the allocated one or more containerized applications 218-1 to 218-N to process the distributed flight data identified in record 210-1 of queue 212-1. Task schedulers 216-2 to 216-N illustrated in FIG. 2 operate in a similar manner. Additional examples and embodiments with regards task schedulers of the present disclosure allocating one or more containerized applications are discussed below with regards to FIG. 19.

In some embodiments, FIG. 8 illustrates the method includes operating 800 the task scheduler to obtain a total number of the plurality of containerized applications of the VE, a number of containerized applications currently running in the VE, a number of records to process in the queue, and a total number of containerized applications that have stopped running in the VE. In this embodiment, FIG. 8 also illustrates the method also includes operating 802 the task scheduler to allocate the one or more containerized applications of the plurality of containerized applications in the VE to process the distributed flight data based on the total number of the plurality of containerized applications of the VE, the number of containerized applications currently running in the VE, the number of records to process in the queue, and the total number of containerized applications that have stopped running in the VE. For example, task scheduler 216-1 illustrated in FIG. 2 obtains a total number of containerized applications 218-1 to 218-N, a number of containerized applications 218-1 to 218-N currently running in VE 214-1, a number of records 210-1 to 210-N to process in the queue, and a total number of containerized applications of containerized applications 218-1 to 218-N that have stopped running in VE 214-1. Task scheduler 216-1 then allocates one or more of containerized applications 218-1 to 218-N of VE 214-1 to process the distributed flight data based on the total number of containerized applications 218-1 to 218-N, the number of containerized applications 218-1 to 218-N currently running in VE 214-1, the number of records 210-1 to 210-N to process in the queue, and the total number of containerized applications of containerized applications 218-1 to 218-N that have stopped running in VE 214-1. Task Schedulers 216-2 to 216-N operate in a similar manner as task scheduler 216-1. Additional examples and embodiments with regards task schedulers of the present disclosure allocating one or more containerized applications are discussed below with regards to FIG. 19.

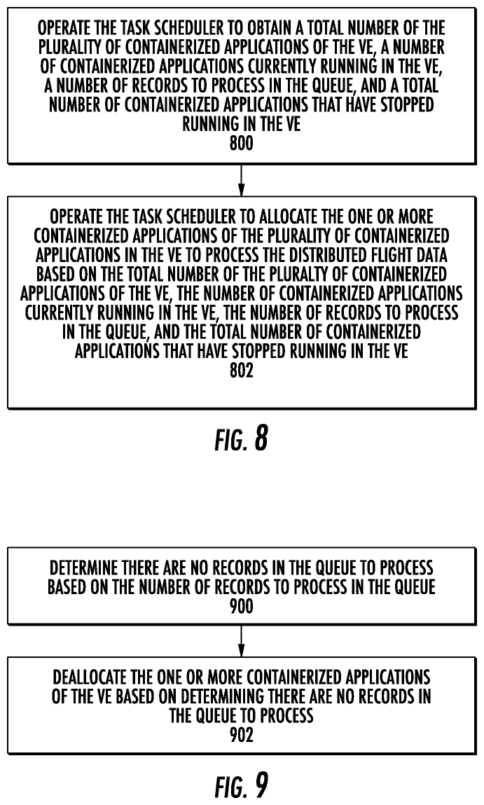

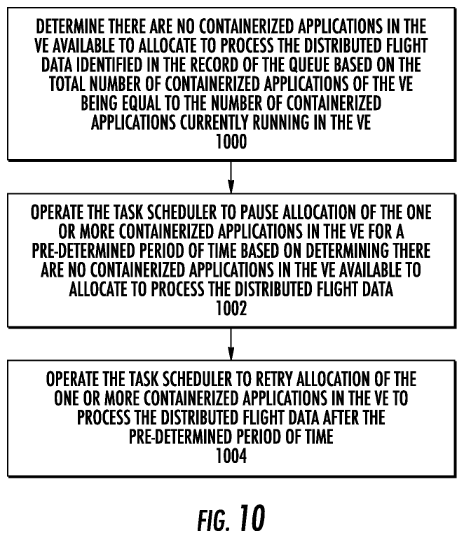

FIG. 9 illustrates the method also includes determining 900 there are no records in the queue to process based on the number of records to process in the queue according to some embodiments. In this embodiment, the method also includes deallocating 902 the one or more containerized applications of the VE based on determining there are no records in the queue to process. For example, task scheduler 216-1 illustrated in FIG. 2 determines there are no records in queue 212-1 to process and then deallocates one or more containerized applications 218-1 to 218-N of VE 214-1 based on determining there are no records in queue 212-1 to process. In some embodiments, the task scheduler may deallocate all containerized applications of the VE based on determining there are no records in the queue to process.

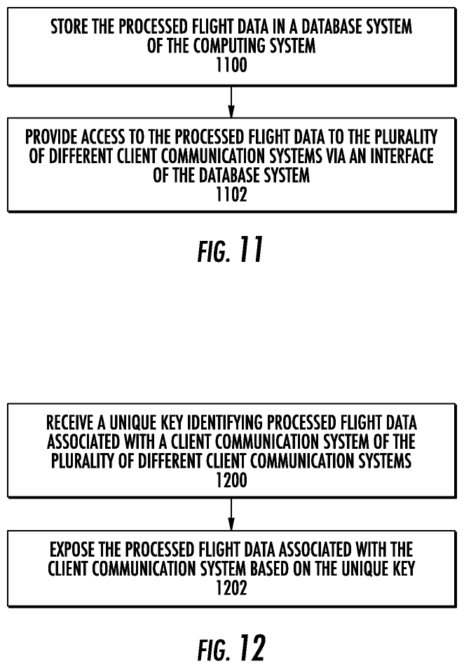

According to some other embodiments, FIG. 10 illustrates the method also includes determining 1000 there are no containerized applications in the VE available to allocate to process the distributed flight data identified in the record of the queue based on the total number of containerized applications of the VE being equal to the number of containerized applications currently running in the VE. For example, task scheduler 216-1 illustrated in FIG. 2 determines there are no containerized applications of containerized applications 218-1 to 218-N of VE 214-1 available to allocate to process the distributed flight data identified in record 210-1 of queue 212-1 based on the total number of containerized applications 218-1 to 218-N of VE 214-1 being equal to the number of containerized applications 218-1 to 218-N currently running in VE 214-1.

Returning to FIG. 10, the method also includes operating 1002 the task scheduler to pause allocation of the one or more containerized applications in the VE for a pre-determined period of time based on determining there are no containerized applications in the VE available to allocate to process the distributed flight data. FIG. 10 also illustrates the method further includes operating 1004 the task scheduler to retry allocation of the one or more containerized applications in the VE to process the distributed flight data after the pre-determined period of time. Continuing the previous example, task scheduler 216-1 pauses allocation of containerized applications 218-1 to 218-N in VE 214-1 for a pre-determined period of time based on determining there are no containerized applications of containerized applications 218-1 to 218-N in VE 214-1 available to allocate to process the distributed flight data. After pausing for the predetermined period of time, task scheduler 216-1 retries allocating one or more of containerized applications 218-1 to 218-N in VE 214-1. Additional examples and embodiments with regards task schedulers of the present disclosure allocating one or more containerized applications are discussed below with regards to FIG. 19.

FIG. 11 illustrates the method also includes storing 1100 the processed flight data in a database system of the computing system and providing 1102 access to the processed flight data to the plurality of different client communication systems via an interface of the database in response storing the processed flight data system according to some embodiments. For example, FIG. 2 illustrates computing system 100 stores processed flight data 226 in database system 228 of computing system 100. In some embodiments, the computing system stores the processed flight data in a database of database system 228, such as database 230 illustrated in FIG. 2. In this example, computing system 100 provides access to processed flight data 226 to client communication systems 106-1 to 106-N via interface 202 of computing system 100. Additional examples and embodiments with providing access to the processed flight data are discussed below with regards to FIG. 20.

FIG. 12 illustrates the method also includes receiving 1200, via the interface, a unique Key identifying processed flight data associated with a client communication system of the plurality of different client communication systems according to some embodiments. The method further includes exposing 1202, via the interface, the processed flight data associated with the client communication system based on the unique Key in this embodiment. Continuing the previous example, computing system 100 receives, via interface 202, a unique Key identifying processed flight data 226 associated with, for example, client communication system 106-1. Computing system 100 then exposes, via interface 202, processed flight data 226 associated with client communication system 106-1 based on the unique Key.

According to some embodiments, a computer program product comprised on a non-transitory computer readable storage medium comprising executable instructions that when executed by processing circuitry of a computing system that operates to process distributed flight data is described. In this embodiment, the executable instructions cause the computing system to perform operations of the methods described above and herein below. In some embodiments, the non-transitory computer readable storage medium comprises memory, such as memory 224-1 to 224-N of computing devices 208-1 to 208-N illustrated in FIG. 2. In some embodiments, the processing circuitry comprises one or more processors 204-1 to 204-N of computing devices 208-1 to 208-N illustrated in FIG. 2. It should be understood that although FIG. 2 illustrates each computing device 208-1 to 208-N comprising a single processor that computing devices 208-1 to 208-N may comprise multiple processors and/or various processing circuitries to perform the operations and methods disclosed herein.

As discussed above, the present disclosure describes describe an application for processing distributed flight data in real-time. In particular, the present disclosure transfers asynchronous raw data of a flight to a multi-threaded queuing mechanism of a distributed computing system 1300 illustrated in FIG. 13. Then, the distributed computing system 1300 manages those entries using a container orchestrated system operating within multiple virtual environments. Executable instructions within these containers process each entry in the queue(s) using an automated task scheduler provided by the corresponding virtual environment. The task scheduler runs a script which outlines the specific programs required to process the data for each flight. Once completed, the distributed computing systems stores the results within a database of the computing system and makes it accessible to each corresponding airline. In some case, the distributed computing system makes the results through an electronic application, such as a mobile application or as a web application.

The queueing mechanism illustrated in FIG. 13 and discussed above with regards to FIGS. 2-6 is a storage device which stores and retrieves data from a list in a definite order, typically by insertion. Distributing computing system 1300 comprises, for example, a cloud computing system that operates externally to aerial and airline communication systems as discussed above. FIG. 13 also illustrates a container-orchestrated system comprising a collection of independent systems operating within a virtual environment as discussed above with regards to FIGS. 2 and 7-10 discussed above. In some embodiments, each system contains an Operating System (OS) level virtualization representing an operating system paradigm. FIG. 13 further illustrates automated task schedulers, according to embodiments, that comprise executable instructions the perform time segmenting operations designed to execute activities at a specified time as discussed above with regards to FIGS. 2 and 7-10 discussed above.

Processing distributed data for individual customers is difficult and time-consuming; especially if that processing depends on some form of grouping. For example, suppose an online media outlet wanted to make a movie accessible to an end user or a group of end users. The outlet may have thousands of movie titles available and thousands of end users. For an individual customer or group to watch an individual movie, the outlet needs a mechanism which can connect the two independently (without disturbing other connections). Furthermore, it must be able to scale; since it will be necessary to carry out this process many times for each customer and or movie.

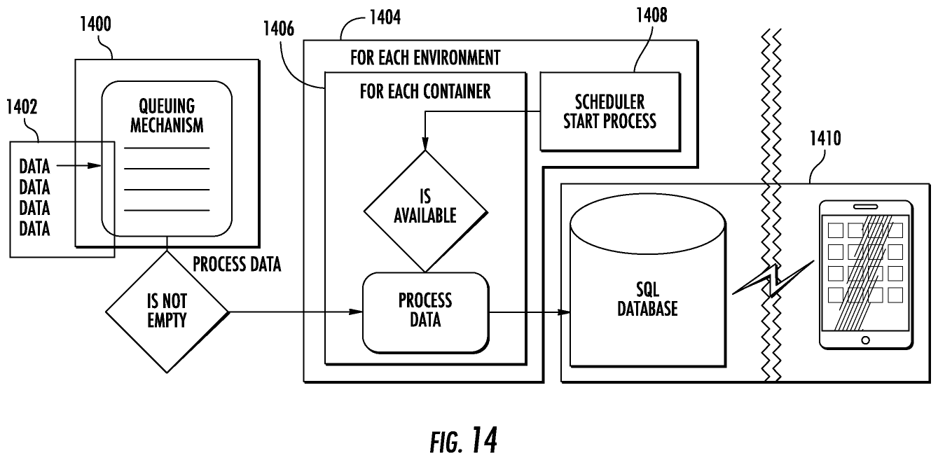

FIG. 14 illustrates an example processing method and an application which can process distributed data for individual customers or groups of customers according to some embodiments. FIG. 14 illustrates the process includes providing 1400 a queuing mechanism within the distributed computing system. The process also includes uploading 1402 raw data to the queuing mechanism as shown in FIG. 14. The process also includes obtaining 1404 multiple OS Virtual Environments and within each environment setting up 1406 a container orchestrated system. FIG. 14 also illustrates the process includes instructing 1408 a task scheduler to process the data in the queuing mechanism within each container. Further, FIG. 14 illustrates the processing includes providing access 1410 to processed data from a centralized database, such as, for example, the Sequel (SQL) database to communication devices and systems external to the distributed computing system.

A queueing mechanism is a term sometimes used to describe a temporary storage device which places and retrieves data to and from a sequenced list while maintaining that list's order. Within a queuing mechanism, additions occur at one end of the list and removals from the other end. A queue typically operates as a first-in-first-out (FIFO) data structure. In a FIFO data structure, the first element added to the queue will be the first one removed. Each element within the queue is independent of each other. When an entry is processed, the system removes it from the list. If an entry fails to process, the entry remains in the list and its corresponding count is incremented. Once an entry's count reaches a predetermined limit, the system flags that entry as an error and removes it from the list.

Queues are effective scaling tools and are less sensitive to individual component failure, due to their ability to buffer data. This prevents the failures of one data object from effecting the performance of others. As discussed herein, when an aircraft's flight data is ready to be processed, the systems and methods described herein uploads the raw content of the flight data to a multi-threaded Queuing Mechanism within the distributing computing system. The queue stores this data temporarily, holding it until enough resources are available to process it. FIG. 15A illustrates an example user interface displaying an individual queue for each airline. This ensures the systems described herein process each airline's data regardless of the airline's size or how many records of flight data it has to be processed. For instance, if one carrier's fleet contained hundreds of planes, while another smaller airline only contains one; known methods and systems may never process the smaller airline's data, if that data is placed in the same queue as the other larger airline. By using multiple queues, grouped by airline, the systems described herein will process everyone's data regardless of (size) limitations.

As shown in FIG. 15A, the example user interface illustrates each customer airline with its own queue. The example user interface identifies each individual queue with a name 1500 and its internal location 1502. In some embodiments, the user interface allows users to manage each queue manually as shown in drop down menu 1504. The system described herein uploads each airline's flight data to its corresponding queue as discussed above with regards to FIGS. 2-6 above. In some embodiments, the method includes utilizing a connection possibly exposed through an API or file transferring protocol to upload the raw data to the Queuing Mechanism of the distributed computing system 1300. In some embodiments, each asynchronous upload is independent from each other.

FIG. 15B illustrates an example user interface displaying contents of an individual customer queue. As shown, the queue identifies each uploaded data entry 1506 with a unique id 1508. Each entry also contains an insertion time 1510 and an expiration time 1512. An entry remains in the queue until the expiration time expires, which is configurable. As discussed herein, the distributed computing system 1300 processes each entry on a first come basis. For example, the distributed computing system 1300 pulls an entry from the top of the queue, while replenishing records from the bottom. When an entry is processed, the distributed computing system 1300 removes it from the queue. If an entry fails to process, the entry remains in the queue, while the invention increments its corresponding count 1514, as demonstrated at 1516. Once an entry's count reaches a predetermined limit, the system 1300 flags that entry as an error and removes it from the queue as discussed above with regards to FIGS. 2 and 5-6. There are many reasons an entry could fail to process; not all of which are fatal. In cases where a non-fatal fault occurs, the system 1300 could retry the entry by moving it to the end of the queue while increasing its queue count.

In order to effectively scale, distributed computing system 1300 uses multiple OS virtual environments. This bonds the resources of each individual environment to the tasks performed within. In some embodiments, users can manage these resources within each environment to improve (or lesson) overall performance. Each environment uses virtual technology to ease swapping configurations and reduce set up times. As shown in the example user interface illustrated in FIG. 16, the system 1300 uses virtual environments 1600 in order to effectively scale. In some embodiments, the user interface provides the ability for users to add 1602 and remove 1604 environments to adjust resources as demand changes. If demand increases, users can onboard additional resources to increase performance. On the other hand, if demand lessons, these resources can be released as well. Each virtual environment hosts an operating system and any other system-wide software needed to support their infrastructure. Furthermore, the distributed computing system 1300 uses a Container Orchestrated System to process the data within each virtual environment. In some embodiments, users can install the container software within each environment; along with any other software needed to process the data.

In order to strengthen scalability, the systems and methods described herein make use of a Container Orchestrated System to divide and efficiently use resources. For example, FIG. 17 illustrates the systems described herein comprise a collection of independently packaged applications 1700-1 to 1700-N called Containers. Each Container operates within a unified environment such as Host Operating System 1702. The environment hosts the operating system and any other system software needed to support its infrastructure 1704. In some embodiments, each Container possesses only the components needed to complete an assigned task. Additional embodiments and examples regarding containerized applications are also discussed above with regards to FIGS. 2-6 discussed above.

In some embodiments, containers are portable units which share the environment's OS system kernel and other system-wide software. They contain all the necessary executable code and dependencies needed for an application to run quickly and reliably within them. In general, a container image is a lightweight, standalone, executable package of software that includes everything needed to run an application: code, runtime, system tools, system libraries and subsequent settings. In some embodiments, users can create Baseline Container images which retain the system-wide resources needed for each container to complete its task. From these images, users can then allocate containers as needed. For example, FIG. 18 shows an example of a Baseline Container image, where each Container is preloaded with a dotnet-framework 1800, a java runtime environment 1802 and some data processing software 1804. Once created, users can add and remove containers to and from that baseline as demand increases or decreases. As discussed above with regards to FIGS. 2-6, in some embodiments the addition and removal of containers is automated.

FIG. 19 illustrates how multiple containers 1900 can run within a single environment. In some embodiments, users can add and remove these containers as needed. In other embodiments, the system adds and removes these containers automatically according to various embodiments described herein. The only limit to the number of containers an environment can hold is the availability of its resources. If the number of containers started exceeds the amount of resources available, then each container's performance could deteriorate as a result.

Within each virtual environment, the systems described herein utilizes a task scheduler to start a script which processes flight data within each container. Most OS Environments support the ability to schedule the launch of a program at a pre-defined time and or after a specified time interval. In some embodiments, the task scheduler resides within the system's environment and not within a container's environment. As shown in the example user interface illustrated in FIG. 20, a task scheduler 2000 runs a predefined scheduled task 2002 using a predefined interval 2004 set by a user of the user interface. Within the configuration of this task, the task scheduler instructs the Environment to start a program using a predefined script 2006. This script is responsible for processing the flight data using the Container-Orchestrated System. In some embodiments, the scheduled task is specific to the Operating System of the VE in which it operates. Once started, the Task Scheduler will run this script continually as triggered within the defined preset interval. In some embodiments, the user can stop, start or restart the task as needed via the user interface.

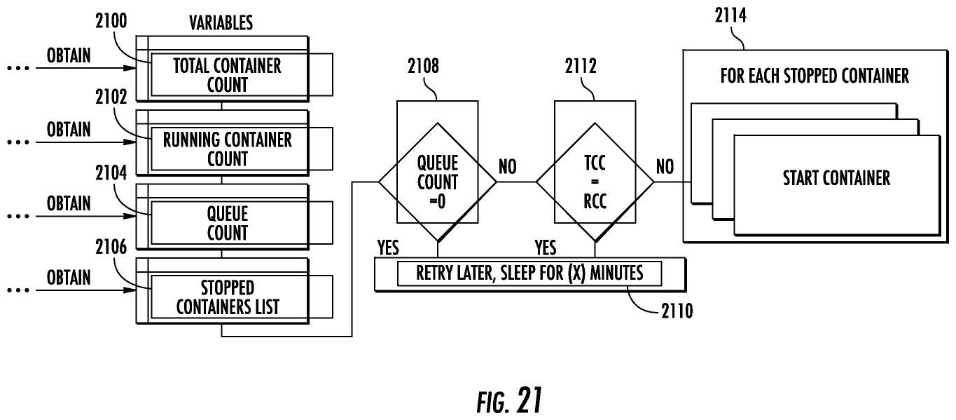

The script started within the task scheduler is responsible for allocating the necessary containers needed to process each flight's data. It uses an algorithm to determine that number, based on the current number of containers available. The chart in FIG. 21 illustrates a process of initiating processing of a flight's data, using the container orchestrated system. First, the program, started by the Task Scheduler, obtains counts for the total Containers 2100, the running Containers 2102 and the records within the Queue 2104. It also maintains a list of the Stopped Containers 2106. The process begins by processing flight records, after checking the Queue Count 2108. If there are no records to process (i.e., Queue Count equals 0), then the Task Scheduler stops running and retries later after a predetermined time 2110.

The Task Scheduler also stops and retries later if there are no Containers available to run, as when the Total Container Count (TCC) is equal to the Running Container Count (RCC) at step 2112. Otherwise, the process cycles through all the stopped Containers and starts each one at step 2114. The process is repeated until it empties the Queue. When a Container starts running, its software locates a predetermined ENTRYPOINT, as defined within the Baseline image. The ENTRYPOINT is a virtual location that designates where the container is to start. This location could point to a batch or command file itself, in which case, the execution would occur within that file's current location. Additional embodiments and examples regarding the task scheduler and containers also described above with regards to FIGS. 2 and 7-10 described above.

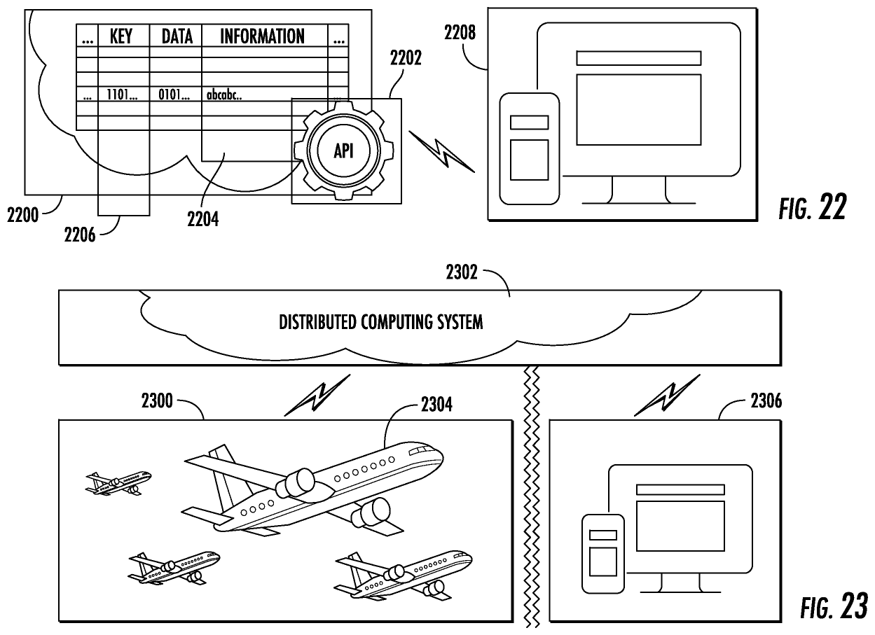

Once the system 1300 processes each airline's data within its containers, it puts the resulting information into a database within the system 1300. This makes the data accessible to airlines through the use of external means. For example, FIG. 22 illustrates a centralized database 2200 within the distributed computing system 1300 provides the processed results to each airline through the use of, for example, but not limited to, an exposed API (Application Programming Interface) 2202. This interface obtains the airline's data 2204 using a unique and identifiable key 2206. Then, the API exposes it using to each corresponding airline through the use of an electronic application 2208; such as a mobile application or a website application/interface. Additional embodiments and examples regarding of providing the data through the use of external means is also described above with regards to FIGS. 2 and 11-12.

FIG. 23 illustrates an example of physical embodiments of the systems described herein. For example, FIG. 23 illustrates how a fleet of aircraft 2300 could transmit flight data to a distributed computing system 2302 using their external antenna systems 2304. After processing the data, the distributed computing system 2302 makes the results accessible to each corresponding carrier through the use of an electronic application 2306; such as, but not limited to, a mobile application and/or a website application. In some embodiments, the distributed computing system 2302 provides each carrier with an authenticated endpoint to access the processed data.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term ““and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents and shall not be restricted or limited by the foregoing detailed description.

We claim:

1. A method, performed by a computing system configured to process distributed flight data, the method comprising:
obtaining distributed flight data from a communication system operating externally from the computing system;
creating a record identifying the distributed flight data in a queue of the computing system;
processing the distributed flight data identified in the record of the queue using a plurality of virtualized environments (VE) of the computing system, each VE of the plurality of VEs comprising a task scheduler and a containerized application that operates to process the distributed flight data; and
providing processed flight data to a plurality of different client communication systems operating externally from the computing system.

2. The method of claim 1, wherein the communication system comprises one of an aerial communication system and an airline communication system operating externally to the computing system.

3. The method of claim 2, wherein obtaining the distributed flight data comprises receiving the distributed flight data from different communication devices operating in one of the aerial communication system and the airline communication system operating externally to the distributed computing system.

4. The method of claim 1, wherein the queue comprises a plurality of different queues of the computing system; and
wherein creating the record identifying the distributed flight data in the queue comprises creating the record identifying the distributed flight data in a queue of the plurality of different queues of the computing system.

5. The method of claim 4, wherein each queue of the plurality of different queues is associated with a different client communication system of the plurality of different client communication systems that operate externally to the communication system; and
wherein creating the record in the queue of the plurality of different queues comprises:
identifying a client communication system of the plurality of different client communication systems associated with the distributed flight data;
selecting the queue of the plurality of different queues based on the identification of the client communication system of the plurality of different client communications systems associated with the distributed flight data; and
creating the record identifying the distributed flight data in the selected queue of the plurality of different queues.

6. The method of claim 1, the method further comprising:
determining the distributed flight data has been successfully processed; and
removing the record identifying the distributed flight data to be processed from the queue based on determining the distributed flight data has been successfully processed.

7. The method of claim 1, the method further comprising:
determining the distributed flight data has not been successfully processed;
responsive to determining the distributed flight data has not been successfully processed, determining a retry count associated with the record identifying the distributed flight data has not met a predetermined retry count limit; and
increasing the retry count associated with the record based on determining the retry count associated with the record has not met the predetermined retry count limit.

8. The method of claim 1, the method further comprising:
determining the distributed flight data has not been successfully processed;
responsive to determining the flight data has not been successfully processed, determining a retry count associated with the record identifying the distributed flight data has met a predetermined retry count limit; and
removing the record based on determining the retry count associated with the record has met the predetermined retry count limit.

9. The method of claim 1, wherein processing the distributed flight data identified in the record of the queue using the plurality of VEs comprises selecting the plurality of VEs to process the distributed flight data based on an amount of computing resources required to process the distributed flight data identified in the record of the queue.

10. The method of claim 9, wherein selecting the plurality of VEs to process the distributed flight data comprises receiving, from a user interface of the computing system, a selection of the plurality of VEs to process the distributed flight data identified in the record of the queue.

11. The method of claim 1, wherein each VE of the plurality of VEs comprises a plurality of containerized applications; and
wherein each containerized application of the plurality of containerized applications of each VE comprises independently executable instructions configured to process the distributed flight data.

12. The method of claim 11, wherein the record identifying the distributed flight data to be processed comprises information identifying a storage device of the computing system storing the distributed flight data; and
wherein each containerized application of the plurality of containerized applications of each VE obtains the distributed flight data from the storage device based on the information identifying the storage device in the record.

13. The method of claim 11, wherein processing the distributed flight data identified in the record of the queue using the plurality of VEs comprises:
for each VE of the plurality of VEs:
operating the task scheduler to allocate one or more containerized applications of the plurality of containerized applications in the VE to process the distributed flight data identified in the record of the queue and
operating the task scheduler to run the allocated one or more containerized applications to process the distributed flight data identified in the record of the queue.

14. The method of claim 12, wherein operating task scheduler to allocate one or more containerized applications of the plurality of containerized applications in the VE to process the distributed flight data identified in the record of the queue comprises:
operating the task scheduler to obtain a total number of the plurality of containerized applications of the VE, a number of containerized applications currently running in the VE, a number of records to process in the queue, and a total number of containerized applications that have stopped running in the VE; and
operating the task scheduler to allocate the one or more containerized applications of the plurality of containerized applications in the VE to process the distributed flight data based on the total number of the plurality of containerized applications of the VE, the number of containerized applications currently running in the VE, the number of records to process in the queue, and the total number of containerized applications that have stopped running in the VE.

15. The method of claim 13, wherein operating the task scheduler to allocate the one or more containerized applications of the plurality of containerized applications in the VE to process the distributed flight data based on the total number of the plurality of containerized applications of the VE, the number of containerized applications currently running in the VE, the number of records to process in the queue, and the total number of containerized applications that have stopped running in the VE comprises:
determining there are no records in the queue to process based on the number of records to process in the queue, and
deallocating the one or more containerized applications of the VE based on determining there are no records in the queue to process.

16. The method of claim 13, wherein operating the task scheduler to allocate the one or more containerized applications of the plurality of containerized applications in the to process the distributed flight data based on the total number of the plurality of containerized applications of the VE, the number of containerized applications currently running in the VE, the number of records to process in the queue, and the total number of containerized applications that have stopped running in the VE comprises:
determining there are no containerized applications in the VE available to allocate to process the distributed flight data identified in the record of the queue based on the total number of containerized applications of the VE being equal to the number of containerized applications currently running in the VE;
operating the task scheduler to pause allocation of the one or more containerized applications in the VE for a pre-determined period of time based on determining there are no containerized applications in the VE available to allocate to process the distributed flight data; and
operating the task scheduler to retry allocating of the one or more containerized applications in the VE to process the distributed flight data after the pre-determined period of time.

17. The method of claim 1, wherein providing the processed flight data to the plurality of different client communication systems operating externally from the computing system comprises:
storing the processed flight data in a database system of the computing system;
responsive to storing the processed flight data, providing access to the processed flight data to the plurality of different client communication systems via an interface of the database system.

18. The method of claim 17, wherein providing access to the processed flight data to the plurality of different client communication systems via the interface of the database system comprises:
receiving, via the interface, a unique Key identifying processed flight data associated with a client communication system of the plurality of different client communication systems; and
exposing, via the interface, the processed flight data associated with the client communication system based on the unique Key.

19. A computing system that operates to process distributed flight data, the computing system comprising:
a first interface configured to communicate with a communication system operating externally from the computing system;
a second interface configured to communicate with a plurality of different client communication systems operating externally from the computing system;
processing circuitry;
memory comprising executable instructions that when executed by the processing circuitry causes the processing circuitry to perform operations comprising:
obtaining, using the first interface, distributed flight data from a communication system operating externally from the computing system;
creating a record identifying the distributed flight data in a queue of the computing system;
processing the distributed flight data identified in the record of the queue using a plurality of virtualized environments (VEs) of the computing system, each VE of the plurality of VEs comprising a task scheduler and a containerized application that operates to process the distributed flight data; and
providing, using the second interface, processed flight data to a plurality of different client communication systems operating externally from the computing system.

20. A computer program product comprised on a non-transitory computer readable storage medium, the computer program product comprising executable instructions that when executed by processing circuitry of a computing system that operates to process distributed flight data, causes the computing system to perform operations comprising:
obtaining distributed flight data from a communication system operating externally from the computing system;
creating a record identifying the distributed flight data in a queue of the computing system;
processing the distributed flight data identified in the record of the queue using a plurality of VEs of the computing system, each VE of the plurality of VEs comprising a task scheduler and a containerized application that operates to process the distributed flight data; and
providing processed flight data to a plurality of different client communication systems operating externally from the computing system.
